(19) United States
(12) Patent Application Publication
(10) Pub. No.: US 2026/0329498 A1
(43) Pub. Date: Oct. 22, 2026

(54) STORAGE MEDIUM, CONTROL METHOD, AND INFORMATION PROCESSING APPARATUS

(71) Applicant: CANON KABUSHIKI KAISHA, Tokyo (JP)

(72) Inventor: KAZUYUKI SAITO, Kanagawa (JP)

(21) Appl. No.: 19/578,085

(22) Filed: Mar. 25, 2026

(30) Foreign Application Priority Data
Apr. 21, 2025 (JP) 2025-069990

(51) Int. Cl. G06F 3/12

(52) U.S. Cl. CPC G06F 3/1255; G06F 3/1204; G06F 3/1287

(57) ABSTRACT

A non-transitory computer-readable storage medium storing an application program that cooperates with an Internet Printing Protocol (IPP) Class Driver and that, when executed by an information processing apparatus communicably connected to a printing apparatus, causes the information processing apparatus to execute processing includes acquiring information about a print setting executable on the printing apparatus, and editing a file describing the print setting based on the information acquired in the acquiring, wherein the information about a print setting executable on the printing apparatus is acquired by IPP, and wherein the file describing the print setting is generated by the IPP Class Driver.

### BACKGROUND

### Field of the Technology

The present disclosure relates to a storage medium, a control method, and an information processing apparatus.

### Description of the Related Art

A configuration for issuing a print instruction to a printing apparatus connected to a host computer by using a printer driver installed on the host computer as software for controlling the printing apparatus is known. An operating system (OS) is installed as basic software on the host computer. The printer driver is configured based on specifications defined by the OS and is called from the OS and then operates. Afa vendor that provides a printing apparatus provides a printer driver compatible with the specifications of the OS, so that a method for issuing a print instruction to the printing apparatus using the OS can be provided.

Windows® has recently provided a standard class driver (hereinafter also referred to as a “standard driver”) that can be commonly used in printing apparatuses provided by a plurality of vendors. Such a standard driver is included in an OS package and can be easily used by connecting any printing apparatus to a host computer. Accordingly, there is no need to separately install a model-specific printer driver suitable for a printing apparatus, which enhances user's convenience.

The standard driver is configured to specify print functions in accordance with PrintCapabilities generated based on information acquired from the connected printing apparatus. This enables a user using the standard driver to specify print functions in accordance with the capabilities of the connected printing apparatus, even when one standard driver is used.

An application for function extension (hereinafter also referred to as an “extension application”) can be associated with the standard driver. The extension application can be provided by a vendor that provides the printing apparatus. The extension application can provide a function (extension function) that cannot be implemented by the standard driver alone, by editing Print Device Capabilities (PDC) generated by the standard driver.

Japanese Patent Laid-Open No. 2019-74906 describes a technique for providing a graphical user interface (GUI) to, for example, display a print preview screen by using the extension application. Also, when the standard driver and the extension application are used, the extension application displays a print preview screen, so that the user can check an image of a print result before printing is performed by the printing apparatus.

However, there is a need for further enhancing the convenience for the user to use the extension application as described in Japanese Patent Laid-Open No. 2019-74906.

The convenience of the extension application described in Japanese Patent Laid-Open No. 2019-74906 is limited.

### SUMMARY

The present disclosure is directed to improving usability of an extension application.

According to an aspect of the present disclosure, a non-transitory computer-readable storage medium storing an application program that cooperates with an Internet Printing Protocol (IPP) Class Driver and that, when executed by an information processing apparatus communicably connected to a printing apparatus, causes the information processing apparatus to execute processing includes acquiring information about a print setting executable on the printing apparatus, and editing a file describing the print setting based on the information acquired in the acquiring, wherein the information about a print setting executable on the printing apparatus is acquired by IPP, and wherein the file describing the print setting is generated by the IPP Class Driver.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a printing system.

FIGS. 2A and 2B are block diagrams each illustrating the printing system according to the first embodiment.

FIG. 3 is a diagram illustrating an example of a splash screen.

FIGS. 4A and 4B are diagrams illustrating an example of Print Device Capabilities (PDC).

FIGS. 5A and 5B are diagrams each illustrating an example of a part of PDC.

FIG. 6 is a diagram illustrating an example of a print setting screen for an extension application.

FIGS. 7A to 7F are diagrams illustrating an example of conflicting settings.

FIG. 8 is a diagram illustrating an example of conflict control rules.

FIGS. 9A to 9C are diagrams illustrating an example of PrintCapabilities (PC).

FIGS. 10A to 10C are diagrams illustrating an example of PrintTicket (PT).

### DESCRIPTION OF THE EMBODIMENTS

Hereinafter, desirable embodiments of the present disclosure will be described in detail with reference to the accompanying drawings. The following embodiments are not intended to limit the present disclosure as defined by the claims, and not all combinations of features described in these embodiments are essential to the solutions of the present disclosure.

Identical components are designated by the same reference numerals, and the redundant description will be omitted.

### First Embodiment

### <Hardware Configuration of Printing System>

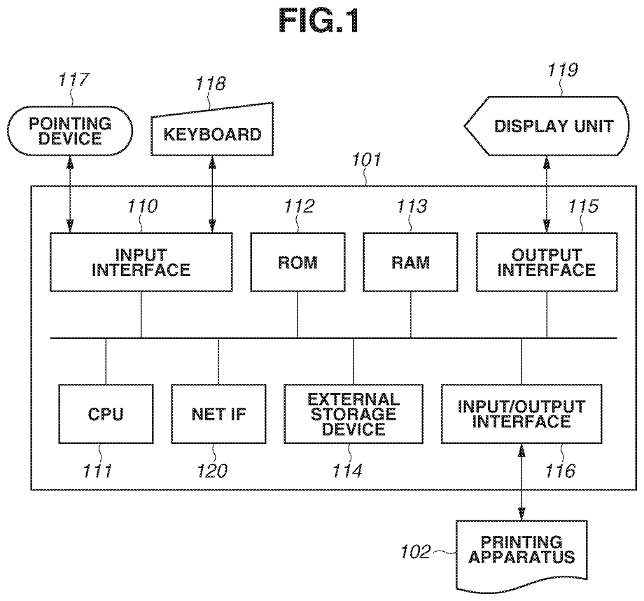

FIG. 1 is a block diagram illustrating a hardware configuration of a printing system. A host computer 101 illustrated in FIG. 1 is an example of an information processing apparatus, and includes an input interface 110, a central processing unit (CPU) 111, a read-only memory (ROM) 112, a random access memory (RAM) 113, an external storage device 114, an output interface 115, and an input/output interface 116.

The input interface 110 is connected to input devices, such as a keyboard 118 and a pointing device 117, and the output interface 115 is connected to a display device, such as a display unit 119.

A network interface (NET IF) 120 is a network interface, and performs control for data transfer between the host computer 101 and an external device via a network.

The ROM 112 stores an initialization program. The external storage device 114 stores a group of application programs, an operating system (OS), print data generation software, and various other types of data. The RAM 113 is used as a work memory or the like when various programs stored in the external storage device 114 are executed, and the various programs can be executed in the host computer 101.

In a first embodiment, the functions of the host computer 101 to be described below and processing related to the flowcharts to be described below are executed by the CPU 111 performing processing according to the procedure of a program stored in the ROM 112. A printing apparatus 102, which is a device, is connected to the host computer 101 via the input/output interface 116.

Although the host computer 101 and the printing apparatus 102 are separately configured, the host computer 101 and the printing apparatus 102 may be configured as a single information processing apparatus. Although the printing apparatus 102 is described using, as an example, an inkjet printer that performs printing by discharging ink onto a paper surface, printing may be executed by any other method (e.g., an electrophotographic method). The host computer 101 may be a desktop personal computer, a smartphone, or a laptop personal computer.

### <Configuration of Printing System Centered on Software>

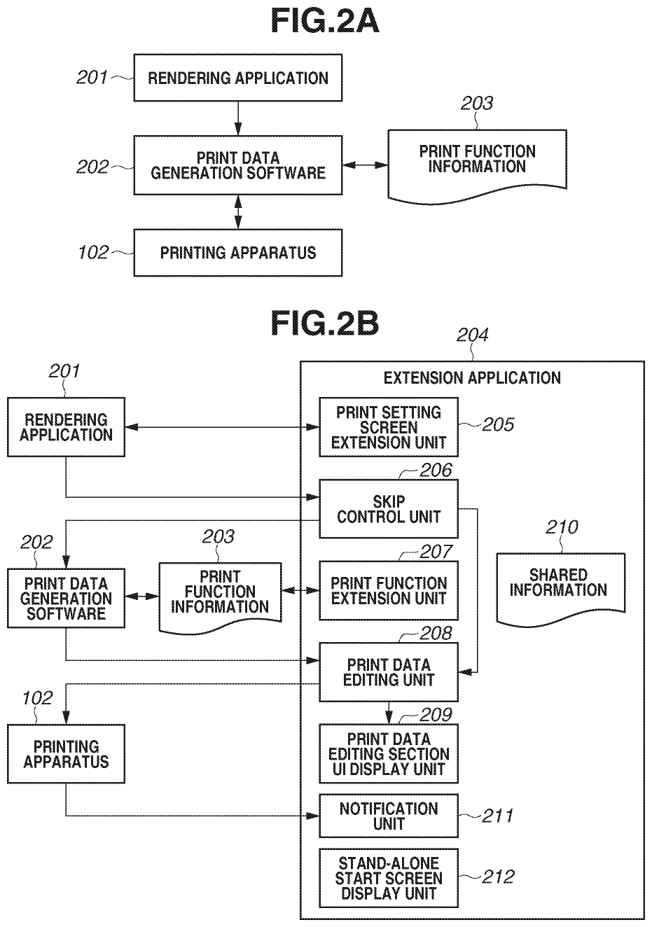

FIGS. 2A and 2B are diagrams schematically illustrating a configuration of the printing system centered on software. The following describes a printing system using the host computer 101 equipped with Microsoft® Windows® as the OS. FIG. 2A illustrates a typical configuration in which an extension application 204 is not associated with print data generation software 202 and the printing apparatus 102.

A rendering application 201 is software for creating a content (drawing data) to be printed. The rendering application 201 corresponds to, for example, a document creation application or a spreadsheet application. In response to receipt of a print request from a user, the rendering application 201 issues a print instruction to the OS. The print instruction includes print setting information for instructing operation of the print data generation software 202 and the printing apparatus 102. The print setting information is also referred to as PrintTicket (PT).

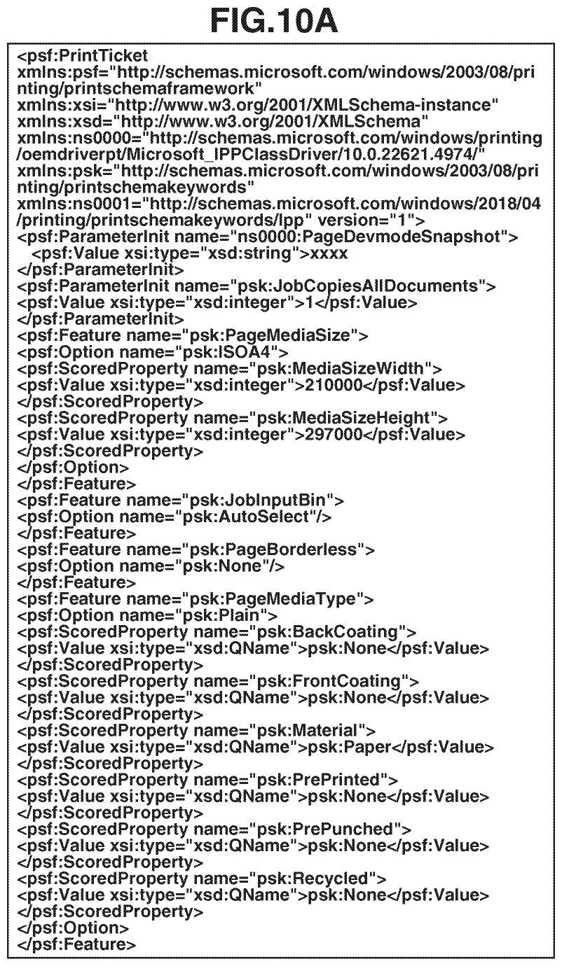

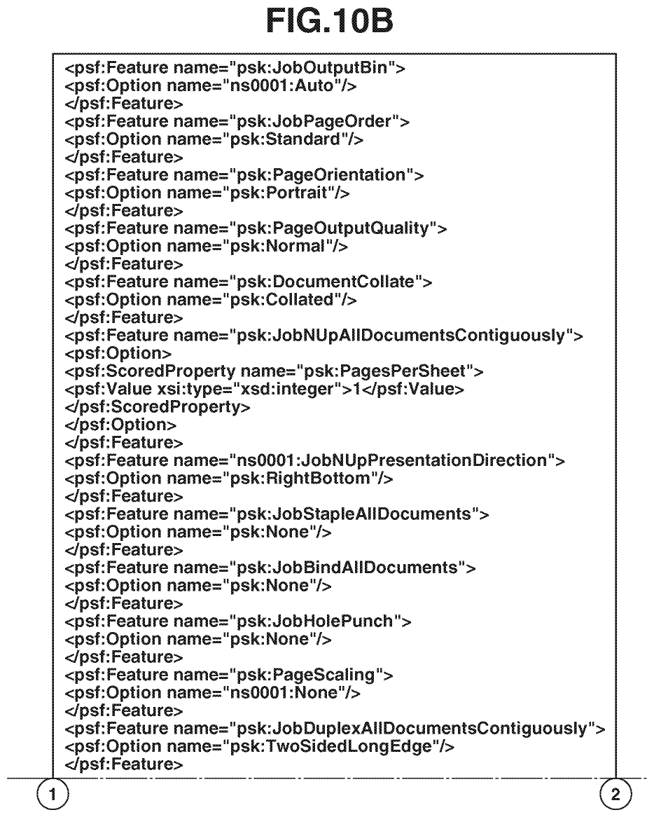

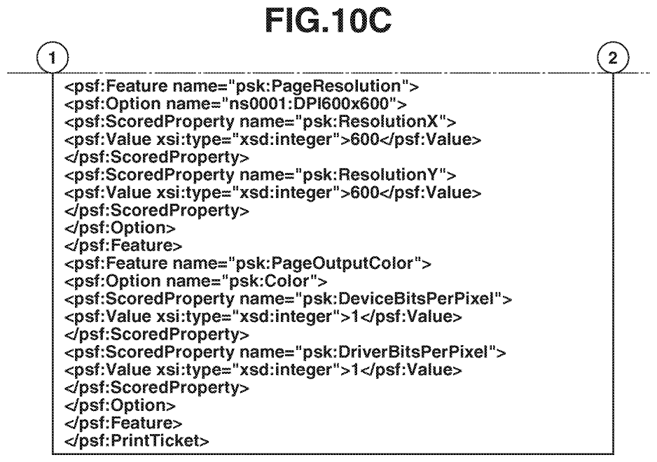

FIGS. 10A to 10C are diagrams illustrating an example of PT. Due to the size of the PT, one Extensible Markup Language (XML) file is divided into three parts as illustrated in FIGS. 10A to 10C, and data illustrated in FIG. 10A is originally followed by data illustrated in FIGS. 10B and 10C. FIGS. 10A to 10C are merely an example of the XML file, and the XML file does not necessarily include all the information illustrated in FIGS. 10A to 10C, and may also include information other than the information illustrated in FIGS. 10A to 10C.

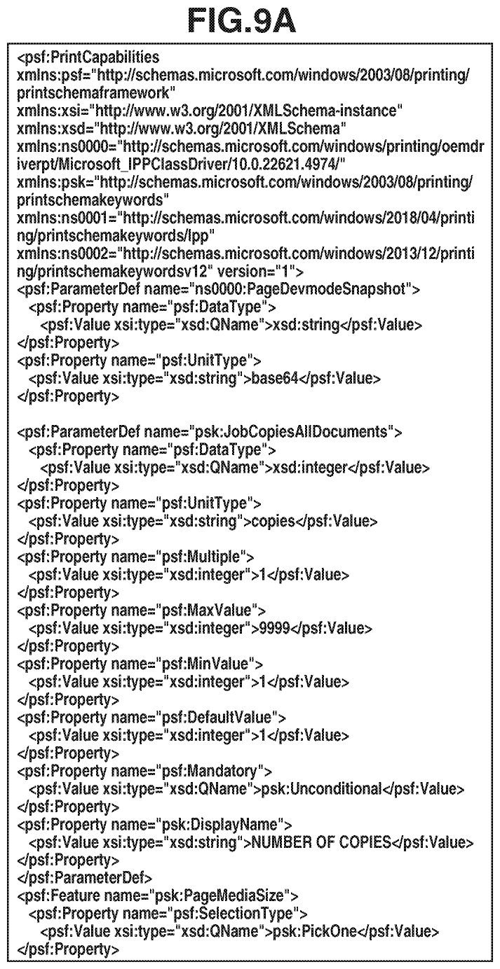

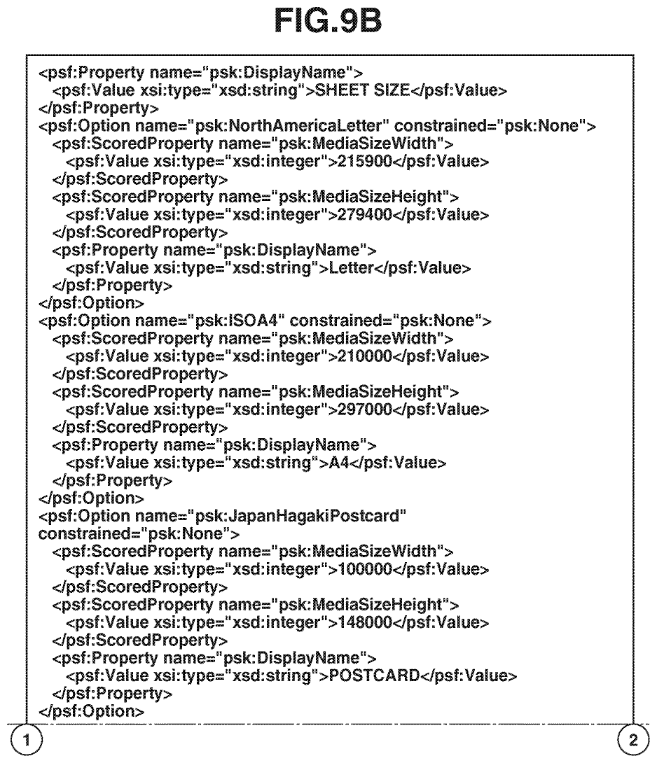

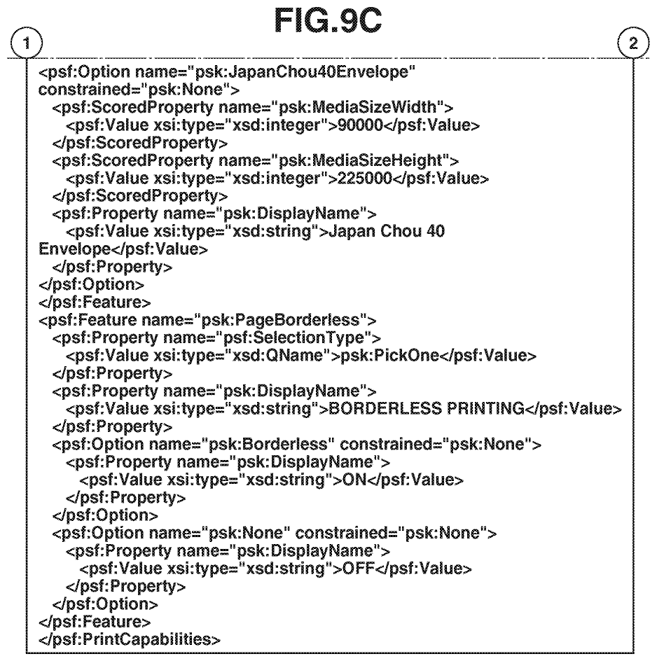

The rendering application 201 can display a print setting screen provided by one of the print data generation software 202, the OS, and the rendering application 201 to output print setting information. The print setting screen includes objects (hereinafter also referred to as “control items”) indicating configurable print functions and control items indicating setting values for the objects, based on capability information (information that can be set as print settings) acquired from the print data generation software 202. The capability information is also referred to as PrintCapabilities (PC). FIGS. 9A to 9C are diagrams illustrating an example of the PC. Due to the size of the PC, one XML file is divided into three parts as illustrated in FIGS. 9A to 9C, and data illustrated in FIG. 9A is originally followed by data illustrated in FIGS. 9B and 9C. FIGS. 9A to 9C are merely an example of the XML file. The XML file does not necessarily include all the information illustrated in FIGS. 9A to 9C, and may also include information other than the information illustrated in FIGS. 9A to 9C.

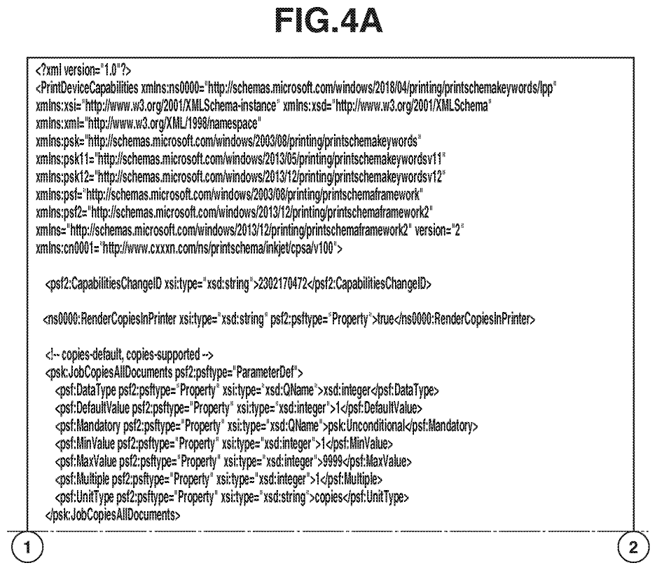

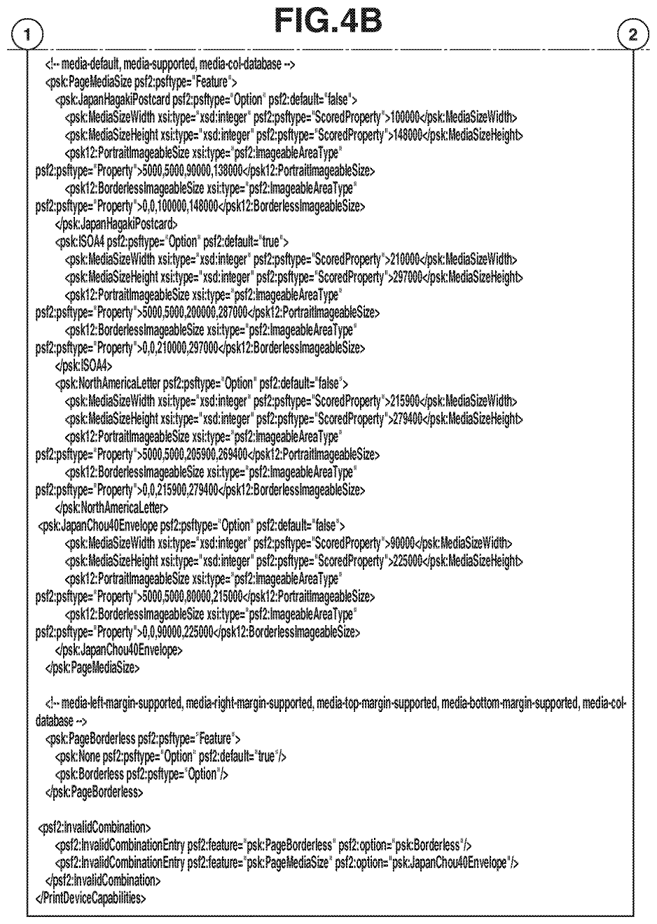

The print data generation software 202 determines PC based on print function information 203. The print function information 203 is data indicating all configurable print functions, setting values for the print functions, and mutual-exclusion relationships between setting values. The print function information 203 is also referred to as Print Device Capabilities (PDC). FIGS. 4A and 4B illustrate an example of PDC. The PDC illustrated in FIGS. 4A and 4B is merely an example. The PDC does not necessarily include all the information illustrated in FIGS. 4A and 4B, and may also include information other than the information illustrated in FIGS. 4A and 4B.

The PDC 203 is included in a configuration file of the print data generation software 202 and is stored in the external storage device 114 as an unchangeable file. Alternatively, the PDC 203 can be dynamically generated by the print data generation software 202. In this case, the PDC 203 generated by the print data generation software 202 can be edited. Specifically, the print data generation software 202 or the OS can acquire attribute data about the printing apparatus 102 from the printing apparatus 102 and generate the PDC 203 based on the attribute information in the acquired attribute data.

The attribute data about the printing apparatus 102 is acquired by issuing a Get-Printer-Attributes operation of Internet Printing Protocol (IPP) to the printing apparatus 102. A response to Get-Printer-Attributes includes attribute information indicating functions (printing apparatus capabilities) that can be specified on the printing apparatus 102 and setting values related to the attribute information. This response is stored in the RAM 113.

With the above-described configuration, the print data generation software 202 can configure print functions in such a manner that the user can specify, in accordance with each connected printing apparatus 102, print functions available for the printing apparatus 102. That is, even when printing apparatuses having different functions or printing apparatuses developed by different vendors are connected, the print data generation software 202 can configure print functions in such a manner that the user can specify, in accordance with each connected printing apparatus, available print functions depending on the connected printing apparatuses.

A configuration in which an IPP Class Driver or Universal Print (UP) Class Driver included in Windows® (or included in the package) as a standard print driver is used as the print data generation software 202 will be described.

IPP Class Driver and UP Class Driver are printer drivers that execute print processing based on specifications of a standard print protocol called IPP, and are included in the OS package.

IPP Class Driver and UP Class Driver are not model-specific printer drivers for the printing apparatus 102, but are standard class drivers that can transmit print data to a plurality of printing apparatuses provided by a plurality of different manufacturers. IPP Class Driver is a standard driver that executes local printing based on the above-described specifications, and UP Class Driver is a standard driver that executes cloud printing.

In the case of executing cloud printing using UP Class Driver, print data is not directly transmitted to the printing apparatus 102, but is transmitted via a cloud printing-related service, and printing is executed on the printing apparatus 102. IPP Class Driver and UP Class Driver acquire capability information for the printing apparatus 102 that has been connected, so that the user can specify print functions supported by the printing apparatus 102, and generate the print function information 203 based on the capability information.

The extension application 204 to be described below operates linked to a print queue for IPP Class Driver or UP Class Driver.

By using IPP Class Driver, the device (printer) supporting IPP Mopria can perform printing without the need for installing a driver manufactured by a vendor or a driver manufactured by a printer manufacturer on the host computer. Windows 11® supports universal serial bus (USB) connection and can use USB connection as well as network connection. Generation of a print queue is performed by automatic generation by Plug & Play (PnP) that is triggered by a device connection, or adding a printer from Devices & Printers in a control panel or from Printers & Scanners in a settings application.

The driver rank, in descending order, is as follows: a higher-rank vendor-supplied outbox driver (installed after start of use of the OS), an IPP Class Driver, a vendor-supplied inbox driver (a driver bundled with the OS), and a model-common driver. In an environment in which IPP Class Driver can be used (environment in which a higher-rank driver is installed, or a higher-rank driver is distributed by Windows Update®), the IPP Class Driver is not used.

IPP Class Driver acquires capability information from a printer when a print queue is generated, and determines availability for the following items: number of copies, sheet size, borderless printing, sheet type, sheet feeding method, page order, printing orientation, color mode, print quality, collating, scaling, double-sided printing, stapling (including stapleless binding), punching, folding, layout printing (N-in-1), and arrangement order. These items may vary depending on the version of the OS.

Universal Print is a cloud print service that is provided by Microsoft®. Through UP Class Driver bundled with the Windows® OS, printing can be performed to printers registered with Universal Print Service.

A print queue is generated by adding a printer from Printers & Scanners on the settings application in an environment in which an Azure AD account is associated with the system. In a case where a desired printer cannot be found by the operation described above, the desired printers may be listed by selecting “Search Universal Print for printers”.

UP Class Driver acquires capability information from Universal Print Service when a print queue is generated, and determines print settings that are configurable. Target functions are similar to those for IPP Class Driver. Prosumer inkjet (IJ) devices do not support Universal Print. By using Universal Print Connector provided by Microsoft®, printers that do not support Universal Print can be registered with Universal Print Service by using a printer driver. However, in a case where Universal Print Connector is used, the extension application 204 is not associated and thus cannot be used even when the target model is used.

The OS generates intermediate data (also referred to as input data) based on a print instruction output from the rendering application 201, and passes the generated intermediate data to the print data generation software 202. Data to be output for printing from the rendering application 201 includes data of Graphics Device Interface (GDI) format or data of XML Paper Specification (XPS) format.

When the print data generation software 202 is used, in a case where the rendering application 201 outputs data in GDI format, the OS converts the data in GDI format output from the rendering application 201 into data in XPS format. The converted data in XPS format is passed to the print data generation software 202 as intermediate data. In a case where the rendering application 201 outputs data in XPS format, the OS passes the data in XPS format to the print data generation software 202 as intermediate data.

The intermediate data includes drawing data serving as information about an image to be formed on a sheet, and print setting information for print settings set by the user.

The print data generation software 202 converts the acquired intermediate data into print data interpretable by the printing apparatus 102 and transmits the print data to the printing apparatus 102. The print data includes drawing data serving as information about an image to be formed on a sheet, and print setting attribute information (attribute information for specifying print settings) generated based on print setting information set by the user. The print setting attribute information includes attribute information indicating functions (printing apparatus capabilities) that can be specified for the printing apparatus 102, and setting values related to the attribute information.

The printing apparatus 102 performs printing on a sheet based on print data transmitted from the print data generation software 202. In this processing, the printing apparatus 102 forms drawing data included in the print data on a sheet by an operation based on the print setting attribute information included in the print data. The print setting attribute information includes attribute information for specifying print quality (image quality priority, speed priority, etc.), double-sided printing, and the like, and setting values thereof. For example, in a case where the print setting attribute information includes attribute information for specifying double-sided printing, the printing apparatus 102 executes double-sided printing.

FIG. 2B illustrates a configuration in which the extension application 204, the print data generation software 202, and the printing apparatus 102 are associated with each other. Configurations and processing not mentioned in particular below are similar to those illustrated in FIG. 2A.

The extension application 204 is also referred to as a Print Support Application (PSA).

The extension application 204 is software for extending functions of the print data generation software 202, and is not included in the OS (not bundled with the OS). Accordingly, the user needs to download and install the extension application 204 from a server via the Internet by operating the host computer 101.

Alternatively, the extension application 204 may be automatically installed in response to the printing apparatus 102 being connected to the host computer 101. Specifically, when the printing apparatus 102 is connected to the host computer 101, the OS acquires device identification information from the printing apparatus 102. The OS may download and install the extension application 204 corresponding to the acquired device identification information from the server via the Internet. In other words, the print data generation software 202 and the extension application 204 are stored as separate files in the host computer 101.

Although the versions of the print data generation software 202 and the extension application 204 may be updated and upgraded, these update processes are also performed at different points in time. That is, the timing when the host computer 101 acquires the print data generation software 202 is different from the timing when the host computer 101 acquires the extension application 204. A trigger for the host computer 101 to acquire the print data generation software 202 is also different from a trigger for the host computer 101 to acquire the extension application 204.

When the extension application 204 is installed, the OS associates the extension application 204 with the print data generation software 202 and the printing apparatus 102.

The extension application 204 described in the first embodiment includes a print setting screen extension unit 205, a skip control unit 206, a print function extension unit 207, a print data editing unit 208, a notification unit 211, and a print data editing section user interface (UI) display unit 209. The extension application 204 also includes shared information 210 that can be accessed in common by the units. The actual content of the shared information 210 is a file stored in the external storage device 114 or information stored in the RAM 113.

The extension application 204 can freely write information to, and read information from, the shared information 210 by using an application programming interface (API) provided by the OS. The shared information 210 is allocated as an area where application-specific information can be stored, and can also store information other than attribute data about the printing apparatus 102.

The shared information 210 is information different from the PDC 203 that is generated by the print data generation software 202 or the OS to specify the print functions available for the connected printing apparatus 102.

The extension application 204 may be terminated each time the processing of each of the units ends. In this case, the OS starts the extension application 204 each time a use request for one of the units is received. Other configurations can also be employed. For example, the OS terminates the extension application 204 when the processing of the print setting screen extension unit 205 ends, but may maintain the extension application 204 running when the processing of the skip control unit 206 ends.

Further, the extension application 204 may cancel processing of each unit during the processing. When the processing is cancelled, the OS deletes the job being processed from the print queue.

In response to receipt of a print request from the user, the rendering application 201 issues a print instruction to the OS. In this configuration, as in the configuration illustrated in FIG. 2A, the rendering application 201 can display a print setting screen. In this configuration, a print setting screen provided by the extension application 204 is displayed. Specifically, a print setting screen provided by the print setting screen extension unit 205 included in the extension application 204 is displayed.

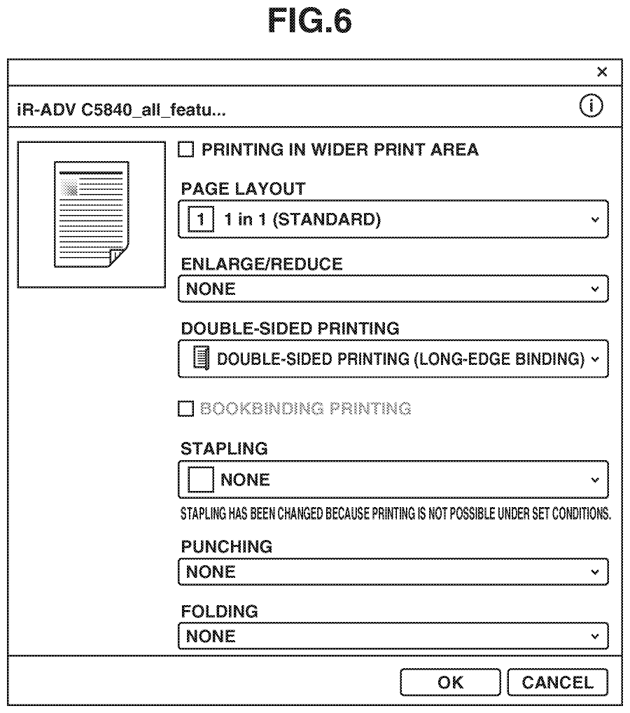

A determination of whether the print setting screen provided by the print setting screen extension unit 205 is displayed depends on a user's operation. For example, the following describes a case in which the rendering application 201 is a document creation application or a spreadsheet application. In such a case, in response to the user pressing a property setting button displayed on the print setting screen provided by the document creation application or the spreadsheet application, the print setting screen provided by the print setting screen extension unit 205 is displayed. The print setting screen extension unit 205 will be described in detail below with reference to FIG. 6.

When the rendering application 201 receives a print request from the user, and a print instruction is issued to the OS, the OS starts the skip control unit 206. The skip control unit 206 controls whether to skip the processing of the print data generation software 202. The skip control unit 206 cannot acquire intermediate data and print setting information. After skip control processing performed by the skip control unit 206, the OS generates intermediate data based on a print instruction output from the rendering application 201 and passes the intermediate data to the print data generation software 202.

In a case where the skip control unit 206 does not perform the skip control processing, the print data generation software 202 processes the intermediate data into print data interpretable by the printing apparatus 102 and passes the print data to the print data editing unit 208.

On the other hand, in a case where the processing of the print data generation software 202 is skipped, intermediate data is passed to the print data editing unit 208 without processing the intermediate data. Thus, the intermediate data can be processed by the print data editing unit 208.

Examples of a desirable case where the processing of the print data generation software 202 may be skipped include a case where scaling processing is desired to be performed by the print data editing unit 208. The intermediate data can retain data in a vector format and is not significantly degraded by scaling. Accordingly, in a configuration in which the print data generation software 202 outputs an image in a raster format, it is generally desirable that the processing of the print data generation software 202 be skipped and the intermediate data be processed by the print data editing unit 208.

The print data editing unit 208 edits the intermediate data passed from the print data generation software 202 or the print data processed by the print data generation software 202. As an example of editing, in layout printing, the print data editing unit 208 changes the layout of the intermediate data or the print data based on print setting information for layout printing received from the OS.

The print data editing unit 208 can request the OS to display a UI screen on the display unit 119. The OS starts the print data editing section UI display unit 209 in accordance with the request from the print data editing unit 208. The print data editing section UI display unit 209 can display, for example, the layout result of the intermediate data or the print data on the display unit 119 as a preview screen.

The print data editing unit 208 does not transmit the print data to the printing apparatus 102 while the UI screen displayed by the print data editing section UI display unit 209 remains open. When the UI screen displayed by the print data editing section UI display unit 209 is closed, the print data editing unit 208 executes print data transmission processing.

After the print data editing unit 208 edits the print data, the print data is passed to the printing apparatus 102 via the OS. The printing apparatus 102 performs printing on a sheet based on the received print data. In a case where the processing of the print data generation software 202 is skipped by the skip control unit 206, the print data editing unit 208 may convert the received intermediate data into print data interpretable by the printing apparatus 102. A function provided by the OS may be used to convert intermediate data into print data.

The extension application 204 includes the print function extension unit 207. The print function extension unit 207 can edit the PDC 203 generated by the print data generation software 202 or the OS. This enables the print function extension unit 207 to, for example, add functions that are provided by the extension application 204, and add functions that are supported by the printing apparatus 102 and are not supported by the print data generation software 202. The print function extension unit 207 can also add, for example, a mutual-exclusion relationship between setting values for the print functions.

The OS starts the print function extension unit 207 when the extension application 204 is first associated with the printing apparatus 102 and the print data generation software 202. Further, the OS may start the print function extension unit 207 at other timings, such as when the OS starts up. With this configuration, in a case in which an option device (for example, a finisher) is added to the printing apparatus 102 later, for example, and a printing-related function is expanded, the print function extension unit 207 can detect the newly available function and can add the extension function to the PDC 203.

Examples of items to be added to the PDC 203 include sheet type, sheet size, stapleless binding (eco-stapling), folding function, layout printing, and 180-degree rotation.

The extension application 204 includes the notification unit 211. The notification unit 211 can display a notification to the user in response to the occurrence of an error in the printing apparatus 102.

For example, in a case where an out-of-paper error occurs in the printing apparatus 102, the print data generation software 202 detects the out-of-paper error, and the OS displays a message on the display unit 119 using a notification function called a toast notification function, as one of the functions of the OS. In response to the user pressing the toast notification, the notification unit 211 of the extension application 204 is called by the OS, and a UI screen of the notification unit 211 is displayed. The UI screen of the notification unit 211 can display, for example, a detailed message regarding the out-of-paper error and a sheet loading method.

Once the print data is transmitted to the printing apparatus 102, the extension application 204 is unable to display a screen, such as a guide linked to the print data, during processing of each unit.

The configuration of the extension application 204 to implement the present embodiment is not limited to the configuration including all the functions (units) described above, but instead may include some of the functions, or may include any other functions. The extension application 204 may also be simply referred to as print software. As described above, the extension application 204 may include at least one of the print setting screen extension unit 205, the skip control unit 206, the print function extension unit 207, the print data editing unit 208, the print data editing section UI display unit 209, and the notification unit 211.

### <Association of Extension Application>

The extension application 204 operates in association with print queues for IPP Class Driver and UP Class Driver. The extension application 204 is not associated with any vendor-provided driver.

The extension application 204 and IPP Class Driver/UP Class Driver are associated using an extension INF file (ExtensionInf). ExtensionInf is installed from Windows Update® in response to connection of a target device. Information about the extension application 204 to be associated is specified in ExtensionInf, and the application is automatically installed from Microsoft Store®. A plurality of models is specified in ExtensionInf. In a case where ExtensionInf corresponding to the model to be used and the application have been installed, the association of the application with a standard print driver is performed even in an offline state. For example, when ExtensionInf in which model A and model B are described is downloaded in response to connection of the model A, the model B can be used without an Internet connection as well.

The extension application 204 is a Universal Windows® Platform (UWP) application. Accordingly, the extension application 204 can be deleted not from the control panel, but from the list of applications in Settings.

### <Splash Screen>

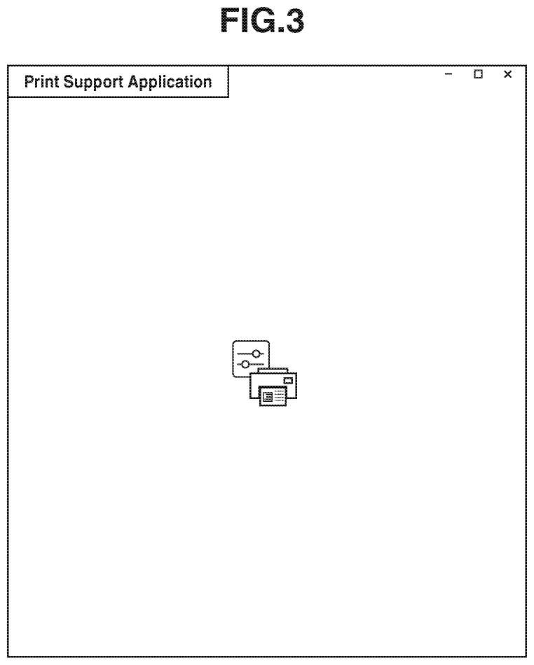

The extension application 204 displays a splash screen (FIG. 3) during start-up with a screen (such as a main screen, a print setting screen, or a status notification screen). The splash screen is a screen indicating that the extension application 204 is starting up. When a close (“×”) button on the splash screen is pressed while the splash screen is displayed, the extension application 204 ends.

A title bar area displayed while the splash screen is displayed is an OS control area, and items (application name, maximize button, minimize button, and close button) that are displayed on this area may vary depending on the screen.

### <Extension of Print Functions>

Extension (addition) of print settings to OS standard printing by the extension application 204 will be described.

The extension application 204 extends selectable print functions and setting items for the print functions and setting items supported by standard printing based on capability information acquired from the printer and unique information held by the application. Print functions can be extended by describing necessary information in a file called Print Device Capabilities (PDC) that defines capability information about the printer.

The actual content of PDC is a file in XML format, and PDC is stored in a predetermined folder for each print queue (OS specifications). The predetermined folder is, for example, “C: \Windows\System32\spool\V4Dirs”.

Examples of the times when the extension application 204 adds a print function include a time when a print queue is generated (in a case where the extension application 204 has been installed in advance), when a print setting screen is started up, when printing is performed, and when the printer is changed in a print dialog of a typical application, such as Office. All the timings are controlled by the OS, and the extension application 204 receives a print function extension instruction from the OS at the above-described timings and the like, so that the print function extension is performed. The print function extension depends on the OS specifications, and thus the print function extension is not necessarily performed at the above-described timings.

An electrophotographic printer and a laser beam printer constantly execute function update processing at the above-described timings to deal with changes in a main-body configuration, such as addition of a finisher. However, once a prosumer inkjet printer has successfully acquired capability information from the printer, cached information is used thereafter without acquiring and updating capability information (renaming, recreation, or the like of a print queue may be required in some cases to prioritize printing completion time, for example, or to update the function). In the case of adding a function, if information to be used to determine whether to add the function fails to be acquired from the printer, function addition processing is not executed.

To add a print setting function, the extension application 204 edits PDC, which is capability information about the standard print driver. The edited content of PDC is reflected in PrintTicket/PrintCapabilities (hereinbelow referred to as PT/PC) generated by the standard print driver.

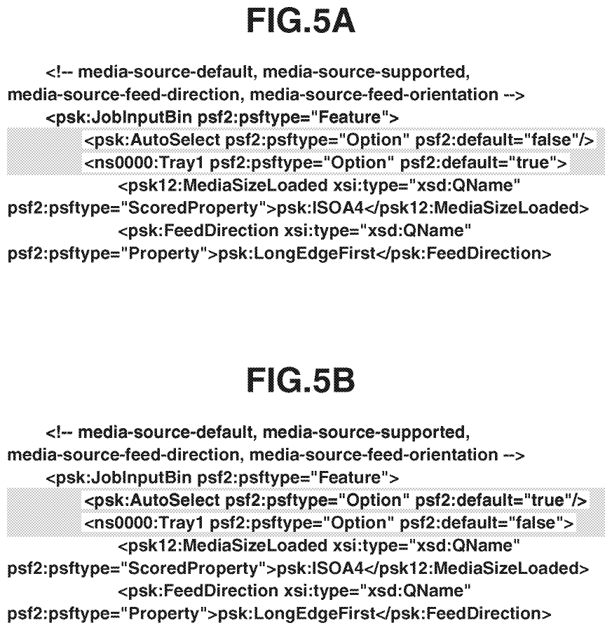

Default values that are applied by default when a print setting screen starts up may also be set in PDC. FIGS. 5A and 5B are diagrams illustrating an example of a part of PDC. FIG. 5A illustrates an example where Tray1 is set (default=“true”) as a default value for a setting item (JobInputBin) of a sheet feed tray. On the other hand, FIG. 5B illustrates an example where automatic selection (AutoSelect) is set (default=“true”) as a default value for the setting item (JobInputBin) of the sheet feed tray.

PrintCapabilities (PC) is generated from PDC and represents printer capability information (functions available in print settings and selectable options that can be specified). The print setting screens of the extension application 204, the OS, and other applications display selection items based on the PC. PrintTicket (PT) represents print settings related to a print job, a document, or a page in a document, and the extension application 204 generates job data based on PT.

### <Addition of Sheet Size Setting Item>

The extension application 204 adds a sheet size setting item as follows.

A sheet size list specified in PDC generated by the standard print driver (IPP Class Driver or the like) is compared with a supported sheet size list acquired from the printer, and sheet sizes that are not described in the PDC and are supported by the extension application 204 are added to the PDC. Sheet size comparison processing is performed by determining whether dimensions (width, height) of sheet sizes match each other. The dimensions and name of each sheet size supported by the extension application 204 are stored as a list of a format, such as {21000, 29700, “A4”}, as known information.

A logic for adding a sheet size, “envelope (You-6) portrait”, is described by way of example. For the sheet size, the dimensions and name {9800, 19000, “jpn_you6_98×190 mm”} can be acquired from the printer. In a case where the sheet size with dimensions {9800, 19000} is not described in PDC generated by the standard print driver, and the sheet size with dimensions matching the dimensions {9800, 19000} is included in the supported sheet size list stored in the application, the above-described sheet size acquired from the printer is added to the PDC.

A sheet size setting item may be added only for Local Print on a prosumer inkjet model.

Examples of sheet sizes to be added include M-OFICIO, Foolscap, FS, 7×10, envelope (You-6) portrait, square (4×4), multi-purpose tray 120×120 mm, B6, B6H, envelope (Kaku-3), envelope (Kaku-4), envelope (Kaku-5), envelope (Kaku-6), envelope (Kaku-7), and envelope (Kaku-8).

In some OS versions, the number of sheet sizes supported as standard increases, and no additional sheet sizes are added by the extension application 204 (for example, in the case of win 11 24H2, all the sheet sizes described above are supported by the OS standards). Further, in a case where 2L size is integrated into “5×7” and B-OFICIO is integrated into the legal size, the sheet sizes may not be handled by the standard print driver and may be excluded from additional target sizes to be added by the extension application 204.

### <Addition of Sheet Type Setting Item>

The extension application 204 adds a sheet type setting item as follows.

A sheet type list described in PDC generated by the standard print driver is compared with a supported sheet type list acquired from the printer, and a sheet type that is not described in PDC is added to the PDC.

Sheet types that are supported by the standard print driver are stored as known information in the extension application 204 and are stored in a format, such as {“stationary”, “Plain”}, as a pair of a name that can be acquired from the printer and a name described in the PDC generated by the standard print driver.

Among the sheet types acquired from the printer, a sheet type that is not described in the stored information is handled as a sheet type to be added to the PDC.

A sheet type setting item may be added only for Local Print on a prosumer inkjet model.

Examples of sheet types to be added may include photo paper glossy gold, photo paper pro platinum grade, photo paper semi-gloss luster, photo paper glossy standard, photo paper satin, matte photo paper, high-quality paper for dedicated use, T-shirt transfer paper, glossy pro crystal grade, third-party fine art paper, printable disc (recommended), printable disc (other), inkjet greeting card, scrapbooking paper, postcard, postcard (address side), inkjet postcard (message side), inkjet postcard (address side), inkjet photo postcard (message side), inkjet photo postcard (address side), iron-on transfer sheet (for white fabric), iron-on transfer sheet (for colored fabric), double-sided matte paper, fine art premium matte, premium fine art rough, Japanese washi paper, photo paper (other), thick paper, paperboard, third-party photo paper, medicine bag, parcel shipping label, glossy label paper, and thin paper.

### <Addition of Layout Printing Function>

The extension application 204 may add a layout printing function setting item.

For example, setting items (options) to be added to an electrophotographic printer may be different from setting items (options) to be added to an inkjet printer. For example, when the extension application 204 is associated with a print queue for an electrophotographic printer, the following setting options: 1 -in-1 (standard), 2-in-1, 4-in-1, 6-in-1, 8-in-1, 9-in-1, 16-in-1 may be added as selectable values for the number of pages per sheet. For example, when the extension application 204 is associated with a print queue for an inkjet printer, the following setting options: 1 -in-1 (standard), 2-in-1, 4-in-1, 6-in-1, 9-in-1, 16-in-1 may be added as selectable values for the number of pages per sheet.

In a case where the extension application 204 is associated with a print queue for an electrophotographic printer, the printer may be caused to perform layout printing processing and the number of pages per sheet may be transmitted from the host computer to the printer. In a case where the extension application 204 is associated with a print queue for an inkjet printer, the extension application 204 may output print data subjected to layout printing processing to the printer. This is because an inkjet printer generally has lower processing capability than that of an electrophotographic printer.

A setting item for an arrangement order may be added. For example, in a case where “2-in-1” is selected as the number of pages per sheet, options such as left-to-right and right-to-left may be selectable when the printing orientation is portrait, and options such as top-to-bottom then left-to-right and top-to-bottom then right-to-left may be selectable when the printing orientation is landscape.

For example, in a case where the number of pages per sheet is four or more, options such as “from upper left to right” and “from upper right to left” may be provided as options.

Further, a setting item for a frame line may be added. For example, “ON” and “OFF” may be provided as options.

<Addition of 180-degree Rotation Function>

The extension application 204 may add a setting item for the 180-degree rotation function.

The options may be ON and OFF.

### <Addition of Stapleless Binding Option>

In a case where the extension application 204 is associated with a print queue for a printer (in particular, an electrophotographic printer) that supports stapleless binding, stapleless binding (upper left, upper right, lower right, lower left) may be added as an option of a stapling setting. The stapleless binding option may be added only when the capability information regarding stapleless binding can be acquired from the printer. <Addition of Bookbinding Printing Function>

In a case where the extension application 204 is associated with a print queue for a printer (in particular, an electrophotographic printer) that supports bookbinding printing, a bookbinding printing function (ON and OFF as options), a bookbinding saddle-stitching function (none, only folding, folding together with saddle-stitching as options), and a book opening direction function (left opening, right opening, top opening, bottom opening as options (linked to printing orientation)) may be added. <Addition of “Automatic Selection” as Setting Option for Color Mode>

The extension application 204 may add “automatic selection” as a setting option for the color mode setting. As a result, for example, color, monochrome, and automatic selection can be selected as options for the color mode. In a case where “color” is selected, color printing may be performed, and in a case where “monochrome” is selected, grayscale printing may be performed. For “automatic selection”, an operation to be performed when the extension application 204 is associated with a print queue for an electrophotographic printer may be different from an operation to be performed when the extension application 204 is associated with a print queue for an inkjet printer.

For example, in a case where “automatic selection” is selected when the extension application 204 is associated with a print queue for an electrophotographic printer, printing may be performed in accordance with default settings on the printer (however, in a case of a monochrome printer, monochrome printing is performed). For example, in a case where “automatic selection” is selected when the extension application 204 is associated with a print queue for an inkjet printer, color printing may be performed (however, in a case of a monochrome printer, monochrome printing is performed).

### <Addition of Resolution>

The extension application 204 may add a resolution setting item “600 dpi”. The resolution setting item “600 dpi” may be added only to a printer that supports portable document format (PDF) printing. In a case where print data (in a page description language (PDL)) to be transmitted to the printer that supports PDF is PDF, the resolution may be forcibly set to 600 dpi.

### <Namespace for Additional Function>

In the case of adding, to the PDC or the like, functions or options that are not defined in the IPP, are not supported by the OS, or are vendor specific, a namespace unique to the vendor is used. However, in a case where functions to be added by the extension application 204 are defined in the IPP or are supported by the OS, the standard namespaces may be used.

<Change depending on Connection Form>

As described above, the content of PDC modifications varies in accordance with the printer type (an inkjet printer, an electrophotographic printer, etc.). Further, the content of PDC to be edited may vary in accordance with a connection form between the printer and the host computer 101. Examples of the connection form include a USB connection, a local network connection, and a connection via a Universal Print server. A determination of whether the printer is connected via Universal Print will be described below by way of example.

First, the extension application 204 determines whether the OS of the host computer 101 supports the API for inquiring about the connection form of the printer. In a case where the OS of the host computer 101 does not support the API for inquiring about the connection form of the printer, the extension application 204 determines that the connection is not Universal Print.

In a case where the OS of the host computer 101 supports the API for inquiring about the connection form of the printer, the API is used to acquire information about the connection type of the printer. In a case where the acquired information indicates “UniversalPrint”, it is determined that the connection form is Universal Print. In a case other than the case where the acquired information indicates “UniversalPrint”, it is determined that the connection is not Universal Print.

Depending on the determination result described above, for example, in a case where the connection form is a Universal Print connection, functions or options that are not defined in the IPP, are not supported by the OS, or are unique to the vendor may not be added to the PDC.

### <Addition of Conflict Control>

Conflicting settings are a combination of print settings that cannot be set at the same time. FIG. 6 is a diagram illustrating an example of a print setting screen that is displayed by the extension application 204. In the example illustrated in FIG. 6, “double-sided printing (long edge binding)” is selected in the setting item for double-sided printing, and thus the stapling setting is restricted. Accordingly, the selected option in the item for stapling has been changed to “none”. A message indicating that “Stapling has been changed because printing is not possible under specified conditions.” is displayed.

In a case where a combination of settings that cannot be set at the same time is specified as described above, the extension application 204 automatically changes the combination of settings to a combination of printable settings, and information indicating that the items have been changed is displayed on the screen. The setting values that cannot be set at the same time may be displayed on a pop-up screen to prompt the user to change the settings. Even in a case where conflicting settings are selected, a print instruction may be issued to the printer without changing the conflicting settings and after the conflicting settings are changed by the printer to settings executable by the printer, the printer executes the job.

Conflict information can also be described in the PDC. A list of combinations of print setting items (and/or setting values, options) that are supported by the printer is acquired from the printer, and all combinations are verified. Any combinations of print setting items (and/or setting values, options) that are not included in the combinations of print setting items (and/or setting values, options) are specified as conflict information in the PDC. Combinations of print settings that cannot be executed by the printer may be acquired, and the combinations may be described as they are.

For combinations of settings about which information cannot be acquired from the printer, conflict information is added in accordance with rules stored in the extension application 204.

The combinations of settings described as conflict information in the PDC are configured such that they cannot be set at the same time. In a case where a conflict occurs in PrintTicket, one of the settings is changed in consistency validation (Validate) processing, so that the conflict is cleared.

Since processing for resolving the conflict in PrintTicket is performed by a logic implemented in the OS, the result of the processing may be different from the result of conflict control performed by the extension application 204.

Also, in the addition of conflict control, the content of conflict control to be added may vary in accordance with the printer model (an inkjet printer, an electrophotographic printer, and the like) and the connection form (USB connection, local network connection, Universal Print connection, and the like). For example, in the case of Universal Print connection, adding conflict control to functions or options that are not defined in the IPP, are not supported by the OS, or are unique to the vendor may be avoided (the above-described method may be employed as a connection form determination method). Conflict control may be added only to a prosumer inkjet printer. The extension application 204 may store a list of combinations of print setting items that can be executed by the printer and rules in the extension application 204, and the extension application 204 may perform conflict control for an electrophotographic printer without using PDC (to be described in detail below).

Examples of conflict control items to be added include sheet type and borderless full-page, sheet feeding method, double-sided printing, and sheet size, borderless full-page and sheet size, and double-sided printing and reverse order printing.

Contents prepared by the OS are described in PDC before the PDC is edited by the extension application 204. Thus, unnecessary conflict control items may be deleted. For example, items corresponding to a combination of “borderless full-page/printing with an expanded printable area” and “sheet type: automatic selection” may be deleted.

### <Conflict Control by Extension Application 204>

Conflict control that is performed by the extension application 204 will be described. In a case where specific options (setting values, choices) for two or more print functions cannot be selected at the same time, conflict control is performed based on the rank (priority) of the conflicting functions. Specifically, options that may cause a conflict for a function with a higher rank are configured to be selectable on a graphical user interface (GUI), and options that may cause a conflict for a function with a lower rank are configured to be unselectable on the GUI.

In the case where a lower-rank function is a combo box having multiple options, an option that causes a conflict is hidden and only options that cause no conflict are displayed. In a case where a function with a lower rank is a function to be set by a checkbox having only an ON/OFF setting, the checkbox is set to a non-conflicting state and is grayed out (disabled).

In a case where a conflict occurs as a result of setting a function with a higher rank, a setting for a function with a lower rank may be automatically changed. In this case, a message indicating that the selected option has been changed is displayed below the corresponding function on the GUI (see FIG. 6). The display of this message is maintained until, for example, a subsequent setting change is performed.

In the case of automatically changing a setting for a function with a lower rank, for example, the setting value is changed to a default value.

The default value for the sheet size setting may be changed based on a display language setting (for example, “letter” in US English setting, and “A4” in other language settings).

In accordance with the printer type (an inkjet printer, an electrophotographic printer, and the like), lower-rank functions may also be allowed to be set.

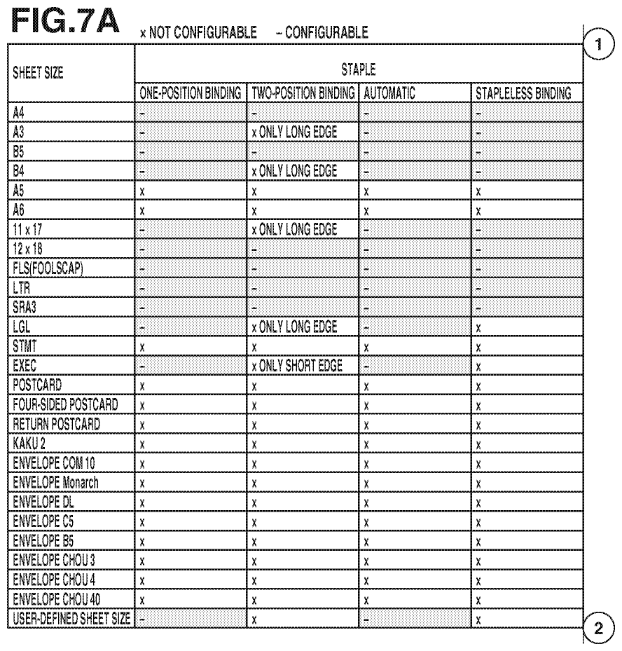

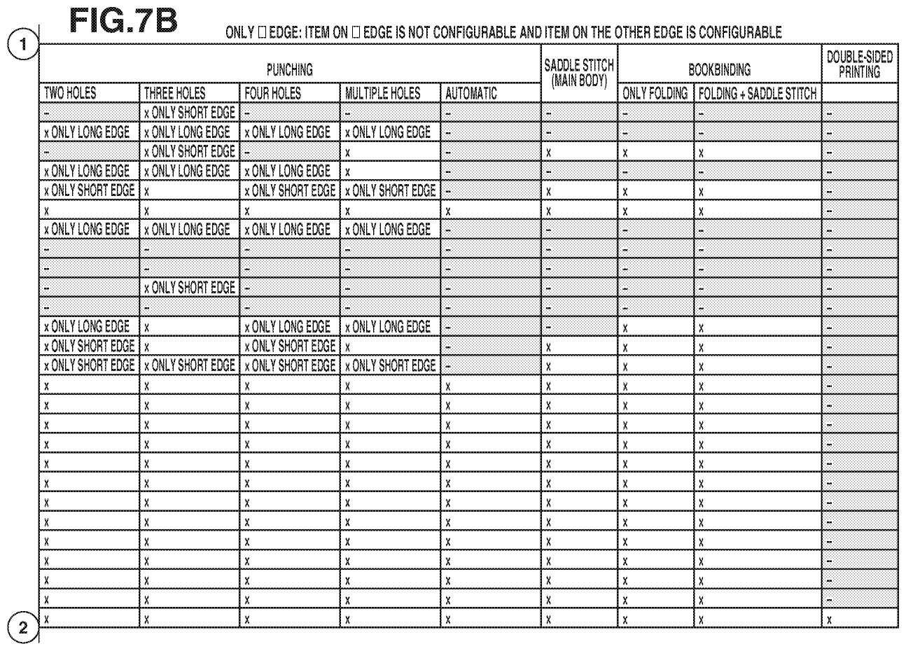

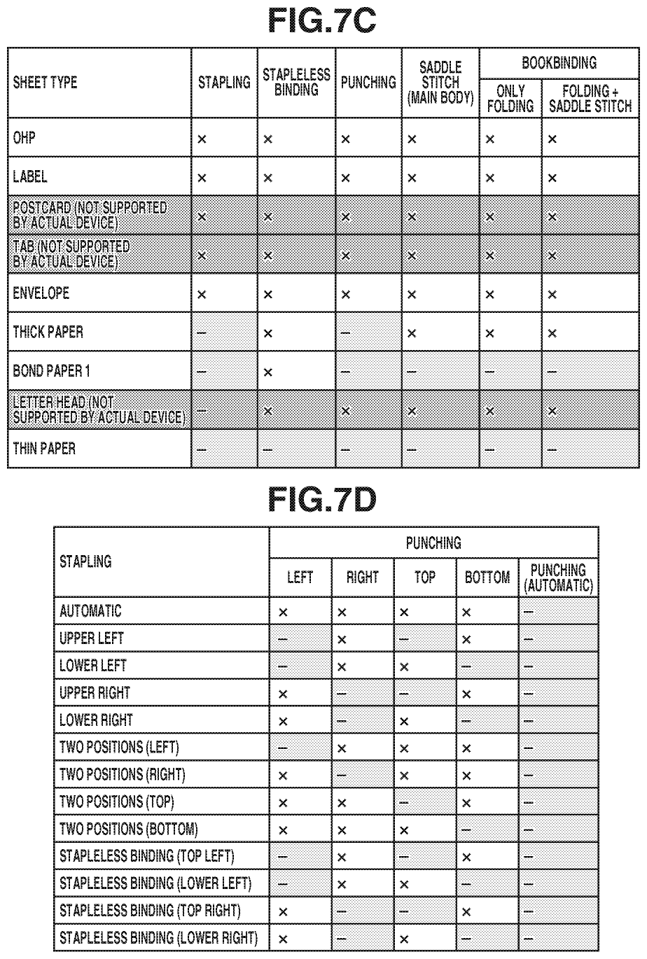

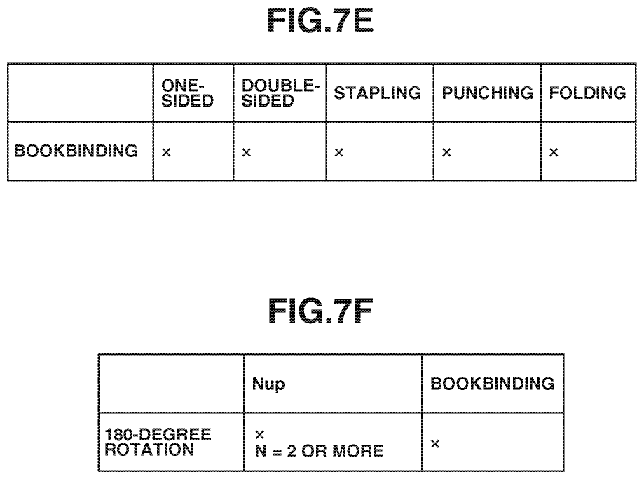

FIGS. 7A to 7F are diagrams illustrating examples of conflicting settings. A combination of settings indicated by “×” in FIGS. 7A to 7F cannot be set at the same time. Items “long edge” and “short edge” illustrated in FIGS. 7A and 7B may be determined based on a binding direction in double-sided printing setting when double-sided printing is set.

In a case where the print setting screen for the extension application 204 is displayed in a state where a combination of conflicting setting values is selected on an application in which an image to be printed is displayed, the selection of the conflicting settings may be cleared without displaying a message indicating that the conflict has been cleared.

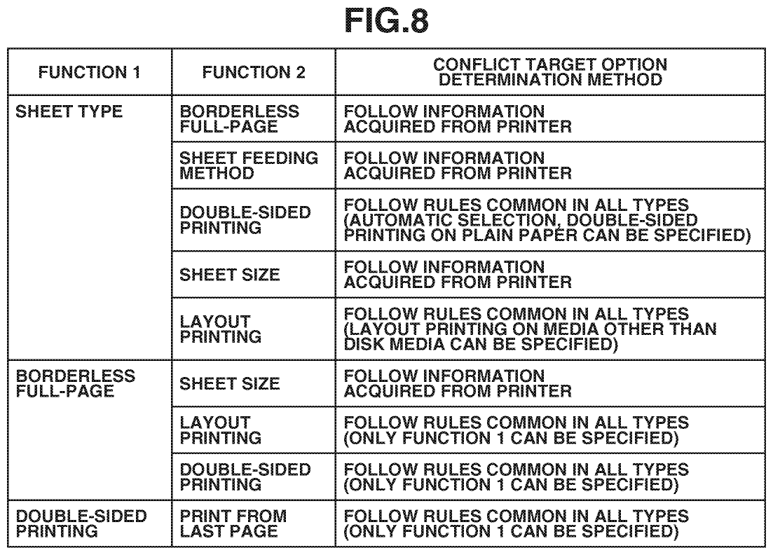

Conflict information illustrated in FIGS. 7A to 7F may be stored in the extension application 204, and the extension application 204 may perform conflict control processing only when a print queue associated with an electrophotographic printer is selected. In a case where a print queue associated with an inkjet printer is selected, different processing may be performed. For example, conflict control for an inkjet printer may be performed according to rules illustrated in FIG. 8.

Conflict control that is performed when “photo paper” is selected as the sheet type may follow the conflict control for setting values for similar setting values, such as “photo paper glossy gold”.

In conflict control, an exception may be made. For example, in a case where “printable disc” is selected, the setting may be exceptionally changed to a setting in which a printable disc is fed from a multi-purpose tray and compact disc (CD)/digital versatile disc (DVD) feed is used, regardless of the rank.

The present disclosure can also be implemented by supplying a program that realizes one or more functions of the above-described embodiments to a system or apparatus via a network or a storage medium, and causing one or more processors of a computer in the system or apparatus to read and execute the program. Furthermore, the present disclosure can also be implemented by a circuit (for example, an ASIC) that realizes one or more functions.

According to the present disclosure, it is possible to enhance the convenience of the extension application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069990, filed Apr. 21, 2025, which is hereby incorporated by reference herein in its entirety.

What is claimed is:

1. A non-transitory computer-readable storage medium storing an application program that cooperates with an Internet Printing Protocol (IPP) Class Driver and that, when executed by an information processing apparatus communicably connected to a printing apparatus, causes the information processing apparatus to execute processing comprising:
acquiring information about a print setting executable on the printing apparatus; and
editing a file describing the print setting based on the information acquired in the acquiring,
wherein the information about a print setting executable on the printing apparatus is acquired by IPP, and
wherein the file describing the print setting is generated by the IPP Class Driver.

2. The storage medium according to claim 1, wherein the editing includes adding an item of the print setting to the file describing the print setting.

3. The storage medium according to claim 1, wherein the editing includes defining a mutual-exclusion condition between items of the print setting based on the information acquired in the acquiring.

4. The storage medium according to claim 1,
wherein the processing further comprises accepting a print setting from a user, and
wherein the file describing the print setting is a file edited to include a setting value of a print setting acceptable in the accepting.

5. The storage medium according to claim 1, wherein the editing includes changing a default value of a setting value corresponding to the print setting in the file describing the print setting.

6. The storage medium according to claim 1, wherein the editing includes adding a setting value of a print setting corresponding to a functional extension of the printing apparatus to the file describing the print setting.

7. The storage medium according to claim 1, wherein the file describing the print setting is a Print Device Capabilities file.

8. The storage medium according to claim 1, wherein in the acquiring, information about the print setting is acquired from Get-Printer-Attributes response information.

9. A control method of an information processing apparatus to be implemented by an application program that cooperates with an Internet Printing Protocol (IPP) Class Driver, the information processing apparatus being communicably connected to a printing apparatus and storing the IPP Class Driver, the control method comprising:
acquiring information about a print setting executable on the printing apparatus; and
editing a file describing the print setting based on the acquired information,
wherein the information about a print setting executable on the printing apparatus is acquired by IPP, and
wherein the file describing the print setting is generated by the IPP Class Driver.

10. An information processing apparatus to be implemented by an application program that cooperates with an Internet Printing Protocol (IPP) Class Driver, the information processing apparatus being communicably connected to a printing apparatus and storing the IPP Class Driver, the information processing apparatus comprising:
at least one memory that stores a set of instructions;
at least one processor that executes the instructions causing the information processing apparatus to perform operations comprising:
an acquisition unit configured to acquire information about a print setting executable on the printing apparatus; and
an editing unit configured to edit a file describing the print setting based on the information acquired by the acquisition unit,
wherein the information about a print setting executable on the printing apparatus is acquired by IPP, and
wherein the file describing the print setting is generated by the IPP Class Driver.
